(19) United States
(12) Patent Application Publication
(10) Pub. No.: US 2007/0269699 A1
(43) Pub. Date: Nov. 22, 2007

(54) Catalyst coated membrane, membrane electrode assembly containing the same, method of producing the same, and fuel cell including the membrane electrode assembly

(75) Inventors: Chan-ho Pak, Yongin-si (KR); Seol-ah Lee, Yongin-si (KR); Hyuk Chang, Yongin-si (KR); Ji-rae Kim, Yongin-si (KR); Dae-jong Yoo, Yongin-si (KR); Sang-hoon Joo, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/708,599

(22) Filed: Feb. 21, 2007

(30) Foreign Application Priority Data
May 16, 2006 (KR) 2006-43941

(51) Int. Cl. H01M 8/10

(52) U.S. Cl. 429/30; 427/115; 429/209; 429/218.1; 429/231.8

(57) ABSTRACT

A catalyst coated membrane (CCM) comprising an anode catalyst layer having a first catalyst layer composed of a non-supported catalyst and a second catalyst layer composed of a supported catalyst, a cathode catalyst layer composed of a supported catalyst, and an electrolyte membrane interposed between the anode catalyst layer and a cathode catalyst layer, the first catalyst layer of the anode catalyst layer being disposed adjacent to the electrolyte membrane; a membrane electrode assembly (MEA) comprising the catalyst coated membrane; a method of preparing the membrane electrode assembly; and a fuel cell comprising the membrane electrode assembly, are provided. The CCM, which comprises a bilayered anode catalyst layer including the first catalyst layer composed of a non-supported catalyst and the second catalyst layer composed of a supported catalyst, exhibits reduced electrical resistance and interfacial resistance, and has increased catalyst availability. The use of the CCM and an MEA having the same results in a decrease in the interfacial resistance between the electrodes and the electrolyte membrane, a decrease in the amount of the catalyst used in the electrode catalyst layer, and a decrease in the thickness deviation in the electrode layers. The fuel cell employing the MEA exhibits maximal activity of the supported catalyst, and has improved cell characteristics such as output voltage, output density, efficiency, and the like.

### CROSS-REFERENCE TO RELATED APPLICATIONS

This application claims the benefit of Korean Patent Application No. 2006-43941, filed May 16, 2006, in the Korean Intellectual Property Office, the disclosure of which is incorporated herein by reference.

### BACKGROUND OF THE INVENTION

1. Field of the Invention

Aspects of the present invention relate to a catalyst coated membrane (CCM), a membrane electrode assembly (MEA) containing the catalyst coated membrane, a method of preparing the catalyst coated membrane, and a fuel cell employing the membrane electrode assembly, and in particular, to a novel catalyst coated membrane employing a bilayered anode catalyst layer with improved catalyst activity, a membrane electrode assembly containing the catalyst coated membrane, a method of producing the catalyst coated membrane, and a fuel cell including the membrane electrode assembly.

2. Description of the Related Art

Active research is being conducted on electrodes, fuel, and electrolyte membranes that are used in fuel cells in order to enhance the power density and the output voltage by increasing the energy density in fuel cells. In particular, there has been an attempt to enhance the catalyst activity of the catalysts used in fuel cell electrodes. The catalysts used in polymer electrolyte membrane fuel cells (PEMFC) or direct methanol fuel cells (DMFC) generally contain platinum (Pt) or alloys of Pt with other metals, and thus, it is desirable to reduce the amount of these catalytic metals in order to secure competitive prices of the catalysts. Accordingly, to reduce the amount of catalyst while maintaining or increasing the performance of a fuel cell, a method of increasing the specific surface area of catalytic metal by using a conductive carbon material having a large specific surface area as a support, and dispersing fine particles of platinum or an alloy onto the conductive carbon material support, is currently being used.

As the effective specific surface area of a catalyst is increased, the catalyst activity is increased, and thus, in order to increase the effective specific surface area, the overall amount of the supported catalyst used can be increased. However, in this case, the amount of the carbon support being used is also increased along with the increase in the overall amount of catalyst, and the thickness of the fuel cell containing the supported catalyst is also increased, thereby leading to an increase in the internal resistance of the fuel cell. It is also difficult to produce an electrode containing an increased amount of supported catalyst. Therefore, it is essential to maintain constant the amount of the support used should, while increasing the concentration of the catalytic metal to be supported. However, before preparing a supported catalyst having a high concentration of catalytic metal, it is necessary to achieve a high degree of dispersion of catalytic metal particles by preparing very fine particles. The supported platinum catalysts that are currently in use have a loading concentration of 20 to 30% by weight. In the case of commercial Pt-supported catalysts, when the concentration of Pt metal particles in the supported catalyst is increased from 20% by weight to 60% by weight, the size of the Pt metal particles also increases by approximately four times. Thus, the effect of increasing the loading concentration cannot be fully utilized when such supported catalysts are actually used in fuel cells.

U.S. Pat. No. 5,068,161 discloses a method of preparing a supported catalyst containing a platinum alloy by a solvent reduction technique, in which an excess amount of water is used as a solvent to dissolve a catalytic metal precursor, hexachloroplatinic acid (H₂PtCl₆). Subsequently formaldehyde is used as a reducing agent to reduce the catalytic metal precursor, and the resulting reduction product is filtered and dried in vacuum.

However, this method involving solvent reduction is disadvantageous in that the size of the catalytic metal particles varies depending on the type of the reducing agent, and the size of the catalytic metal particles also becomes too large at high loading concentrations of 30% by weight or greater.

In another method of preparing a carbon-supported catalyst, a catalytic metal precursor is dissolved in an excess amount of a solvent, a carbon support is impregnated with the catalytic metal precursor, the solvent is removed by drying, and then the catalytic metal precursor loaded onto the carbon support is reduced using hydrogen gas (H. Wendt, Electrochim. Acta, 43, 3637 (1998)). According to this method, since the solvent is added in an excess amount, a concentration gradient is generated in the process of drying, and since the concentration gradient induces a capillary phenomenon, a discharge of the catalytic metal precursor onto the pore surfaces of the carbon support may occur. Also, there still remains a problem in that the size of the catalytic metal particles increases as the loading concentration increases. Moreover, it is still necessary to correlate the performance of MEAs with increased activity of such supported catalysts.

### SUMMARY OF THE INVENTION

An aspect of the present invention provides a catalyst coated membrane (CCM) which allows electrode catalyst layers to exhibit maximal catalyst activity and can enhance the performance of a unit cell, a membrane electrode assembly (MEA) including the catalyst coated membrane, and a method of producing the membrane electrode assembly.

Another aspect of the present invention also provides a fuel cell which employs the membrane electrode assembly and has improved power density and output voltage performance.

According to an aspect of the present invention, there is provided a catalyst coated membrane (CCM), comprising an anode catalyst layer having a first catalyst layer composed of a non-supported catalyst and a second catalyst layer composed of a supported catalyst; a cathode catalyst layer composed of a supported catalyst; and an electrolyte membrane interposed between the anode catalyst layer and the cathode catalyst layer, the first catalyst layer of the anode catalyst layer being disposed adjacent to the electrolyte membrane.

According to another aspect of the present invention, there is provided a membrane electrode assembly (MEA), comprising an anode having an anode catalyst layer containing an anodic first catalyst layer composed of a non-supported catalyst and an anodic second catalyst layer composed of a supported catalyst, an anode diffusion layer, and a backing layer; a cathode having a cathode catalyst layer composed of a supported catalyst, a cathode diffusion layer and a backing layer; and an electrolyte membrane interposed between the anode and the cathode, the first catalyst layer of the anode catalyst layer being disposed adjacent to the electrolyte membrane.

According to another aspect of the present invention, there is provided a method of preparing a membrane electrode assembly (MEA), the method comprising coating a composition for forming a cathode catalyst layer, which contains a supported catalyst, an ion-conductive binder, and a solvent, onto a supporting film and drying the composition to form the cathode catalyst layer on the supporting film; coating a composition for forming an anodic second catalyst layer, which contains a supported catalyst, an ion-conductive binder, and a solvent, onto a supporting film and drying the composition to form the anodic second catalyst layer, and coating a composition for forming an anodic first catalyst layer, which contains a non-supported catalyst, an ion-conductive binder, and a solvent, onto the anodic second catalyst layer and drying the composition to form the anodic first catalyst layer; disposing an electrolyte membrane between the cathode catalyst layer formed on a supporting film, and the anodic first catalyst layer formed on the anodic second catalyst layer, and hot pressing the resulting assembly; peeling off the supporting films from the cathode catalyst layer and the anodic second catalyst layer of the resulting hot pressed assembly in order to obtain a catalyst coated membrane (CCM); and sequentially laminating a cathode diffusion layer and a backing layer onto the exposed surface of the cathode catalyst layer of the CCM, sequentially laminating an anode diffusion layer and a backing layer onto the exposed surface of the anodic second catalyst layer, and hot pressing the resulting assembly.

According to another aspect of the present invention, there is provided a fuel cell including the membrane electrode assembly.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating the laminate structure of a membrane electrode assembly (MEA) according to an embodiment of the present invention;

FIG. 2A is a flow diagram illustrating a process for preparing a supported catalyst according to an embodiment of the present invention;

FIG. 2B is a flow diagram illustrating a process for producing an electrode catalyst layer according to an embodiment of the present invention;

FIG. 3 is a diagram illustrating a process for producing an MEA according to an embodiment of the present invention;

FIG. 4 is a diagram illustrating the laminate structure of an eight-layered MEA according to an embodiment of the present invention;

FIG. 5 is a set of X-ray diffraction analysis spectra of the supported catalysts prepared in Example 1 and Comparative Example 1 of the present invention;

FIG. 6 is a set of X-ray diffraction analysis spectra of the supported catalysts prepared in Example 2, Comparative Example 2 and Comparative Example 3 of the present invention;

FIG. 7 is a graph showing the cell potential versus the current density in fuel cells including the supported catalysts prepared in Example 2, Comparative Example 2 and Comparative Example 3 of the present invention; and

FIG. 8 is a scanning electron micrograph of the anode catalyst layer produced in Example 3 of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A membrane electrode assembly (MEA) according to an embodiment of the present invention employs as the electrode catalyst layers a bilayered anode catalyst layer having an anodic first catalyst layer composed of a non-supported catalyst and an anodic second catalyst layer composed of a supported catalyst, and a single-layered cathode catalyst layer composed of a supported catalyst.

In the anode catalyst layer, the anodic first catalyst layer is disposed adjacent to the electrolyte membrane so as to reduce any interfacial resistance and electrical resistance, while the anodic second catalyst layer is disposed adjacent to the anode diffusion layer so as to facilitate the diffusion of liquid fuel and to increase the catalyst availability. The MEA according to this current embodiment of the present invention, which employs a bilayered anode catalyst layer, has an asymmetric structure.

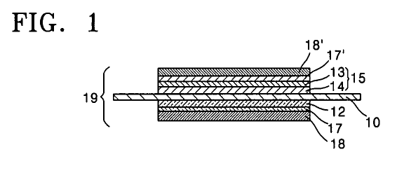

FIG. 1 is a diagram illustrating the structure of an eight-layered MEA according to an embodiment of the present invention.

Referring to FIG. 1, the MEA 19 includes a cathode catalyst layer 12, which is composed of a supported catalyst and formed adjacent to the lower side of an electrolyte membrane 10, and also includes a cathode diffusion layer 17 and a backing layer 18, which are sequentially formed underneath the cathode catalyst layer 12.

An anode catalyst layer 15, having an anodic first catalyst layer 14 composed of a non-supported catalyst and an anodic second catalyst layer 13 composed of a supported catalyst, is laminated onto the upper side of the electrolyte membrane 10, and an anode diffusion layer 17′ and a backing layer 18′ are sequentially formed on top of the anodic second catalyst layer 13.

The thickness of the anodic first catalyst layer 14 and the anodic second catalyst layer 13 may be 10 to 40 μm, while the ratio of the thickness of the anodic first catalyst layer 14 to the thickness of the anodic second catalyst layer 13 may range from 1:0.5 to 1:2. If the thickness of the anodic first catalyst layer or the anodic second catalyst layer is larger than 40 μm, supply of the reactants will not be easily achieved. If the ratio of the thickness of the anodic first catalyst layer and the anodic second catalyst layer is beyond the aforementioned range, the balance between the rate of fuel supply and the electrical resistance of the catalyst layers will be broken, and optimal performance may not be achieved.

The thickness of the cathode catalyst layer 12 may be 10 to 80 μm.

For the supported catalysts used in the cathode catalyst layer and the anodic second catalyst layer, supported catalysts having high dispersion are used. These supported catalysts may be prepared by a method of preparing a supported catalyst having a desired amount of loaded catalytic metal particles according to an embodiment of the present invention, the method comprising preparing a primary supported catalyst containing catalytic metal particles, which are obtained by a primary gas phase reduction reaction of a portion of the final loading amount of catalytic metal, and reducing the remaining portion of the catalytic metal by a secondary liquid phase reduction reaction using the primary supported catalyst. According to the current embodiment, a supported catalyst having excellent dispersion can be prepared by dividing the total amount of the catalytic metal precursor into two portions, and loading the divided portions of catalytic metal precursor successively onto a porous carbon support while subjecting the two different portions of the catalytic metal precursor to two separate reduction reactions by two different reduction modes so as to form catalytic metal particles having a small average particle size on a carbon support having a large pore volume.

That is to say, the first loaded portion of the catalytic metal precursor particles is first subjected to a primary gas phase reduction reaction to form catalytic metal particles having a small average particle size within the micropores or mesopores of the carbon support, and the second loaded portion of the catalytic metal precursor particles is then subjected to a secondary liquid phase reduction reaction so that relatively more of the catalytic metal particles resulting from this liquid phase reaction are formed on the surface of the carbon support. Thus, a supported catalyst having catalytic metal particles with a small average particle diameter can be loaded onto the support surface in a large loading amount.

According to an embodiment of the present invention, the carbon support has micropores or mesopores having a diameter of 2 to 10 nm, and the catalytic metal particles have an average particle diameter of 1 to 5 nm.

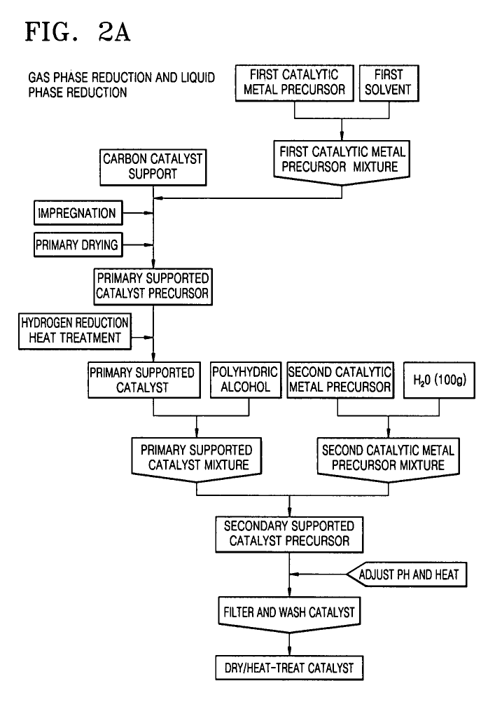

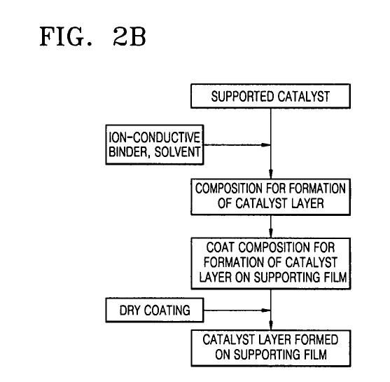

FIG. 2A is a diagram illustrating a process for preparing a supported catalyst according to an embodiment of the present invention. Referring to FIG. 2A, the method of preparing a supported catalyst by sequentially conducting a gas phase reduction reaction and a liquid phase reduction reaction is performed as described below.

First, a first catalytic metal precursor and a first solvent are mixed to obtain a first catalytic metal precursor mixture. The first catalytic metal precursor may be a salt containing at least one metal selected from the group consisting of platinum (Pt), ruthenium (Ru), palladium (Pd), rhodium (Rh), iridium (Ir), osmium (Os) and gold (Au). Examples of the platinum precursor include tetrachloroplatinic acid (H₂PtCl₄), hexachloroplatinic acid (H₂PtCl₆.xH₂O), potassium tetrachloroplatinate (K₂PtCl₄), potassium hexachloroplatinate (K₂PtCl₆), and mixtures thereof. Examples of the ruthenium precursor include ammonium hexachlororuthenate [(NH₄)₂RuCl₆], ammonium aquopentachlororuthenate (NH₄)₂[RuCl₅(H₂O)], ruthenium trichloride (RuCl₃.xH₂O) and the like, while examples of the gold precursor include hydrogen tetrachloroaurate (H₂AuCl₄), ammonium tetrachloroaurate [(NH₄)₂AuCl₄], hydrogen tetranitroaurate [HAu(NO₃)₄.H₂O] and the like. In the case of using metal alloys, a precursor mixture having a mixing ratio corresponding to the ratio of the metal atoms contained in the alloy is used.

The first catalytic metal precursor may be contained in the first catalytic metal precursor mixture in an amount of 20 to 40% by weight of the first catalytic metal precursor mixture. When the amount of the first catalytic metal precursor is more than 40% by weight, catalytic metal particles will be formed inside as well as outside the pores of the carbon support, and thus, the catalytic metal particles grow in size or have a non-uniform particle size distribution. When the amount of the first catalytic metal precursor is less than 20% by weight, very small catalytic metal particles are formed inside the support pores, so that the catalyst utilization may be lowered.

As the first solvent, acetone, methanol, ethanol and the like may be used. The solvent may be used in an amount of 60 to 80% by weight of the first catalytic metal precursor mixture.

Subsequently, a carbon support for a catalyst and the first catalytic metal precursor mixture are mixed, and then the resulting mixture is dried to obtain a primary supported catalyst precursor. The carbon support is not particularly limited, and for example, a porous carbon support having a specific surface area of 250 m²/g or greater, such as 500 to 1200 m²/g, and an average particle diameter of 10 to 1000 nm, such as 20 to 500 nm may be used. If the specific surface area is smaller than 250 m²/g, the carbon support may have insufficient loading capacity for catalytic metal particles.

Examples of the carbon supports which satisfy these conditions include carbon black, Ketjen black (KB), acetylene black, activated carbon powder, carbon molecular sieves, carbon nanotubes, microporous activated carbon, and ordered mesoporous carbon, and mixtures thereof may be used. In particular, it is preferable to use the ordered mesoporous carbon, which has an average pore diameter of 2 to 10 nm.

The proportion of the carbon support in the primary supported catalyst will be appropriately adjusted such that the amount of the catalytic metal particles contained in the primary supported catalyst is 25 to 45% by weight of the primary supported catalyst. It is desirable to use 30 to 40% by weight of the primary supported catalyst, for maximum dispersion and utilization of the supported catalyst.

The drying temperature in the process of primary drying may be from ambient temperature (approximately 25° C.) to 50° C., and in particular, the ambient temperature (approximately 25° C.).

Subsequently, the primary supported catalyst precursor is subjected to hydrogen reduction heat treatment to obtain the primary supported catalyst. The temperature for the hydrogen reduction heat treatment may be 100 to 300° C. If the temperature for the hydrogen reduction heat treatment is below 100° C., the rate of the catalyst reduction reaction becomes so slow that reduction may not be completely achieved, thereby leading to incomplete formation of catalytic metal particles. If the temperature is above 300° C., the rate of the catalyst reduction reaction becomes so fast that aggregation of the catalytic metal particles may occur, thereby resulting in undesirable, large-sized catalytic metal particles.

The amount of the catalytic metal particles contained in the primary supported catalyst obtained as described above may be 25 to 45% by weight of the primary supported catalyst.

The primary supported catalyst is then mixed with a polyhydric alcohol to obtain a primary supported catalyst mixture. For the polyhydric alcohol, ethylene glycol, diethylene glycol, triethylene glycol and the like may be used, and the ratio of the polyhydric alcohol to the primary supported catalyst should be 30:1 by weight to 520:1 by weight of the primary supported catalyst. When the ratio of the polyhydric alcohol to the primary supported catalysts less than 30:1 by weight, the catalytic metal particles tend to aggregate during the reduction reaction, thereby forming large-sized particles. When the ratio of the polyhydric alcohol to the primary supported catalysts greater than 520:1, the reduction reaction cannot take place on the surface of the carbon support, and the primary supported catalyst remains in colloidal form in the polyhydric alcohol, in which case further catalyst production is inhibited.

Meanwhile, in a separate process, a second catalytic metal precursor and a second solvent are mixed to obtain a second catalytic metal precursor mixture. As the second catalytic metal precursor, a salt containing at least one metal selected from the group consisting of platinum (Pt), ruthenium (Ru), palladium (Pd), rhodium (Rh), iridium (Ir), osmium (Os) and gold (Au) may be used, as in the case of the first catalytic metal precursor. Example of the platinum precursor include tetrachloroplatinic acid (H₂PtCl₄), hexachloroplatinic acid (H₂PtCl₆.xH₂O), potassium tetrachloroplatinate (K₂PtCl₄), potassium hexachloroplatinate (K₂PtCl₆), and mixtures thereof. Examples of the ruthenium precursor include ammonium hexachlororuthenate [(NH₄)₂RuCl₆], ammonium aquopentachlororuthenate (NH₄)₂[RuCl₅(H₂O)], ruthenium trichloride (RuCl₃.xH₂O) and the like, while examples of the gold precursor include hydrogen tetrachloroaurate (H₂AuCl₄), ammonium tetrachloroaurate [(NH₄)₂AuCl₄], hydrogen tetranitroaurate [HAu(NO₃)₄.H₂O] and the like. In the case of using metal alloys, a precursor mixture having a mixing ratio corresponding to the ratio of the metal atoms contained in the alloy is used.

The second catalytic metal precursor mixture contains the second catalytic metal precursor in an amount of 0.2 to 0.8% by weight, in particular, 0.40 to 0.55% by weight of the second catalytic metal precursor mixture. If the amount of the second catalytic metal precursor is less than 0.40% by weight, the relative quantity of the primary supported catalyst mixture is increased, and thus, catalytic metal particles will not be formed onto the carbon support but will exist in the form of colloidal particles in the solvent. When the amount of the second catalytic metal precursor exceeds 0.55% by weight, the amount of the primary supported catalyst mixture to be reduced by the second catalytic metal precursor is insufficient, and the second catalytic metal particles undesirably form large-sized particles.

As the second solvent, water, polyhydric alcohols and the like may be used.

Thereafter, the primary supported catalyst mixture previously obtained and the second catalytic metal precursor are mixed to obtain a secondary supported catalyst precursor mixture.

The secondary supported catalyst precursor mixture may contain water in an amount of 30 to 70% by weight of the secondary supported catalyst precursor mixture. If the amount of water is less than 30% by weight, the reducing power of the catalytic metal ions, such as Pt ions, is decreased, and large-sized particles are formed. If the amount of water is greater than 70% by weight, the reducing power of the catalytic metal ions is increased, and numerous small-sized particles will be formed, which will finally undergo aggregation.

The pH of the secondary supported catalyst precursor mixture obtained as described above is adjusted and then heated to obtain a supported catalyst.

The pH of the secondary supported catalyst precursor mixture is adjusted to 7 to 14, for example, from 9 to 13, and then, the secondary supported catalyst precursor mixture is heated. When the pH of the mixture is lower than 9, the catalytic metal particles, such as Pt particles, form a colloid in the secondary supported catalyst precursor mixture and no supported catalyst is formed. When the pH of the mixture is higher than 13, the catalytic metal particles undergo aggregation on the surface of the carbon support and undesirably large-sized particles are generated.

The heating temperature may be 90 to 115° C., such as 105 to 110° C., and the heating rate may be 1 to 20° C./min, such as 1.5 to 5° C./min. If the heating temperature is below 90° C., the catalytic metal particles do not undergo complete reduction. If the heating temperature is higher than 115° C., sudden boiling of the reaction solution occurs, and the amount of water in the reaction solution changes so that the size of the catalytic metal particles undesirably increases. Furthermore, if the heating rate is less than 1.5° C./min, the rate of generation of the catalytic metal particles, such as Pt particles, is lowered, and the size of the catalytic metal particles increases. If the heating rate exceeds 5° C./min, very small catalytic metal particles will be prepared and undergo aggregation, which is not desirable.

Under the conditions as described above, the resulting product is cooled to ambient temperature (about 25° C.), and then is subjected to a series of work-up processes, including filtering, washing and freeze-drying, to finally obtain the supported catalyst of this embodiment of the present invention.

According to the current embodiment, a supported catalyst comprising a carbon support and catalytic metal particles supported on the carbon support can be obtained. Such a supported catalyst contains the catalytic metal particles in an amount of 40 to 90% by weight and the carbon support in an amount of 10 to 60% by weight of the supported catalyst. The average particle diameter of the catalytic metal particles is 1 to 5 nm.

A supported catalyst provided according to an embodiment of the present invention may contain catalytic metal particles supported on a carbon support in a high loading amount, such as 40 to 90% by weight of the supported catalyst. In this case, a portion of the total loading amount of the catalytic metal particles, such as 20 to 45% by weight, is loaded by the primary gas phase reduction reaction, and the remaining portion, namely, 20 to 70% by weight, is loaded by the secondary liquid phase reduction method. The reason for dividing the loading amount into two portions is that the primary gas phase reduction reaction is for loading the catalytic metal particles inside the internal pores of the carbon support so as to decrease the size of the catalytic metal particles, while the secondary gas phase reduction reaction is for loading the catalytic metal particles onto the external surfaces of the carbon support so that both operations increase the catalyst availability. This mixed mode of loading allows the production of a catalyst having a high concentration of catalytic metal particles highly dispersed.

The supported catalyst according to this current embodiment of the present invention can be applied to the catalyst layers of the membrane electrode assembly of fuel cells.

FIG. 2B is a diagram illustrating a process for producing an electrode catalyst layer according to an embodiment of the present invention. Referring to FIG. 2B, the process according to this embodiment of the present invention will be discussed.

First, the supported catalyst prepared according to the previously described embodiment of the present invention is mixed with a solvent and an ion-conductive binder to obtain a composition for forming a catalyst layer. This composition for forming the catalyst layer is coated onto a supporting film and dried to form a catalyst layer on the supporting film.

The catalyst layer formed on the supporting film is laminated onto an electrolyte membrane, and the supporting film is peeled off from the resulting laminate. When the process is performed for both the cathode catalyst layer and the anode catalyst layer, a complete catalyst coated membrane (CCM) is obtained.

As the supporting film, polyethylene film (PE film), polyethylene terephthalate film (for example, MYLAR®), polytetrafluoroethylene film (PTFE, for example, TEFLON®), polyimide film (for example, KAPTON®) and the like are used. The method of coating is not particularly limited, and conventional coating methods such as bar coating, spray coating, screen printing, and the like may be used.

As the solvent in the composition for forming the catalyst layer, water, ethylene glycol, isopropyl alcohol, and polyalcohols can be used, and such a solvent may be used in an amount of 1.5 to 1 to 2.5 to 1 by weight of the supported catalyst.

Various ionomers may be used as the ion-conductive binder. A representative example thereof is a sulfonated, highly fluorinated polymer (e.g., NAFION® manufactured by DuPont Corp.) having a main chain composed of fluorinated alkylene and side chains composed of fluorinated vinyl ether and sulfonic acid groups at the terminals, and other polymeric materials having similar properties can be also used as the ion-conductive binder. The ion-conductive binder is dispersed in a mixed solvent of water and alcohol, for example, in an amount of 5 to 50% by weight of the supported catalyst.

The electrode catalyst layer produced according to this current embodiment of the present invention can be formed onto a supporting film as illustrated in FIG. 2B, but it is also possible to form a catalyst layer by coating the composition for forming the catalyst layer directly onto the electrolyte membrane and drying the assembly.

The supported catalyst according to embodiments of the present invention can also be used as a catalyst for various chemical reactions such as, for example, hydrogenation, dehydrogenation, coupling, oxidation, isomerization, decarboxylation, hydrocracking and alkylation.

Hereinafter, a fuel cell according to an embodiment of the present invention, which uses the supported catalyst this embodiment of the present invention, will be described. In particular, a direct methanol fuel cell will be described.

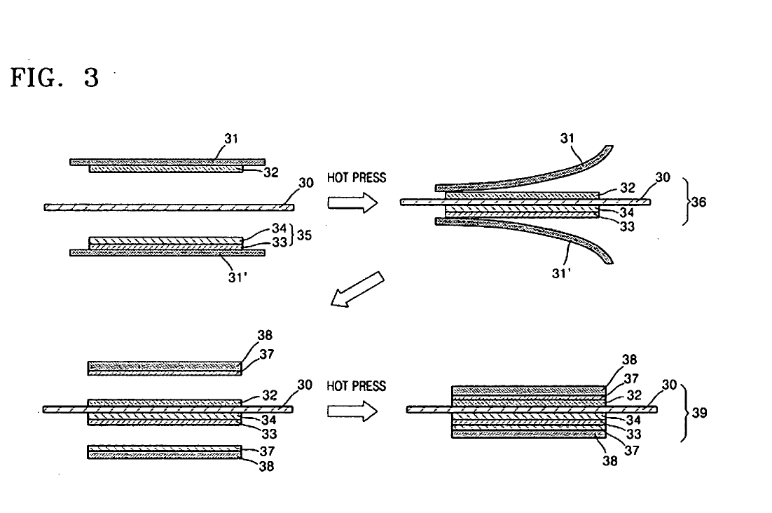

FIG. 3 is a diagram illustrating processes for producing a catalyst coated membrane (CCM) and a membrane electrode assembly (MEA), which together constitute a direct methanol fuel cell according to an embodiment of the present invention.

Referring to FIG. 3, a cathode catalyst layer 32 formed onto a supporting film 31 is disposed on the upper side of an electrolyte membrane 30, and a bilayered anode catalyst layer 35 formed onto a supporting film 31′ is disposed on the lower side of the electrolyte membrane 30. As an example of the cathode catalyst layer 32, a catalyst layer containing a mesoporous carbon-supported platinum catalyst (Pt/MC) supported catalyst can be used, and as an example of the anode catalyst layer 35, a bilayered catalyst layer consisting of an anodic non-supported catalyst layer 34 composed of a metallic catalyst, such as PtRu black, and an anodic supported catalyst layer 33, such as a mesoporous carbon-supported platinum-ruthenium catalyst (PtRu/MC) layer, these anodic catalyst layers being sequentially laminated, can be used. In this case, the PtRu black layer 34 is disposed adjacent to the electrolyte membrane 30.

The resulting assembly is then hot pressed, and the supporting films 31 and 31′ are peeled off from the cathode catalyst layer 32 and the anode catalyst layer 35, respectively, to obtain a four-layered catalyst coated membrane 36. Here, the process of hot pressing is performed at a temperature of 80 to 150° C. and at a pressure of 2 to 10 tons for 1 to 20 minutes. For example, the process of hot pressing may be performed at 125° C. and at about 5 tons for 10 minutes. When hot pressing is performed under such conditions, there is an advantage in that the binding strength between the layers constituting the CCM is enhanced.

Subsequently, a cathode diffusion layer 37 and a backing layer 38 are sequentially laminated onto the cathode catalyst layer 32, and an anode diffusion layer 37′ and a backing layer 38′ are sequentially laminated onto the supported catalyst layer 33 of the anode catalyst layer 35.

The resulting assembly is hot pressed again to obtain an eight-layered MEA 39. Here, the process of hot pressing is performed at a temperature of 80 to 150° C. and at a pressure of 2 to 10 tons for 1 to 20 minutes. When hot pressing is performed as described above, the binding strength between the diffusion layers and the catalyst layers is enhanced, thereby the electrical resistance can be decreased, and the MEA can be firmly integrated.

While FIG. 3 illustrates an eight-layered MEA, it is also possible to produce a trilayered CCM formed using a single-layered supported catalyst layer as the anode catalyst layer, and a seven-layered MEA employing the trilayered CCM.

The backing layers 38 and 38′ shown in FIG. 3 may be formed from a porous material such as carbon paper and carbon cloth, and carbon paper is mainly used according to an embodiment of the present invention.

As an exemplary material for the electrolyte membrane 30, cation-exchangeable polymer electrolyte, such as a sulfonated, highly fluorinated polymer (e.g., NAFION® manufactured by DuPont Corp.) having a main chain composed of fluorinated alkylene, and side chains composed of fluorinated vinyl ether and sulfonic acid groups at the terminals, is used.

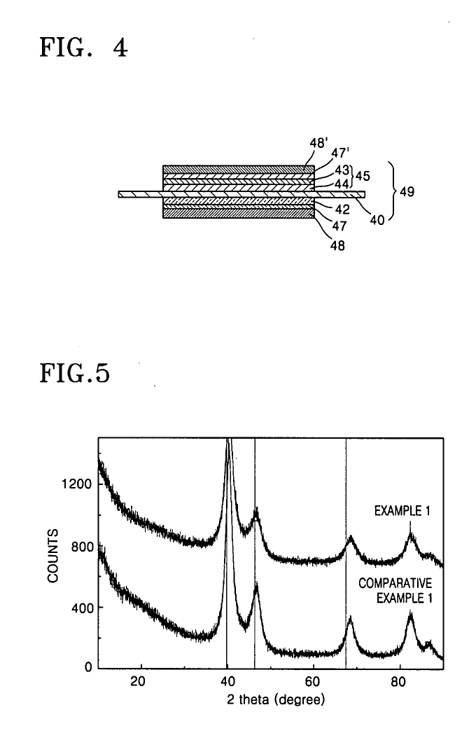

FIG. 4 is a diagram illustrating the structure of an eight-layered MEA according to an embodiment of the present invention.

Referring to FIG. 4, the eight-layered MEA 49 has a structure in which an anode catalyst layer 45 including an anodic first catalyst layer 44 composed of a non-supported catalyst, PtRu black, and an anodic second catalyst layer 43 composed of a supported catalyst, PtRu/MC, is laminated onto one side of the electrolyte membrane 40, and an anode diffusion layer 47′ and carbon paper 48′ as a backing layer are sequentially disposed on top of the anodic second catalyst layer 43.

On the other side of the electrolyte membrane 40, a cathode catalyst layer 42 composed of a supported catalyst, Pt/MC, and a cathode diffusion layer 47 and carbon paper 48 as a backing layer are sequentially disposed underneath the cathode catalyst layer 42.

Hereinafter, the present invention will be described in detail with reference to the following Examples, but the present invention is not intended to be limited by these Examples.

### EXAMPLE 1

0.89 g of hexachloroplatinic acid (H₂PtCl₆.xH₂O) and 0.40 g of ruthenium chloride (RuCl₃.xH₂O), which are catalytic metal precursors, were respectively dissolved in 2.5 ml of acetone and mixed to obtain a corresponding catalytic metal precursor mixture, and then 1 g of mesoporous carbon as a carbon support was impregnated with the catalytic metal precursor mixture in a plastic bag. The impregnated carbon support was placed in an electric furnace and subjected to a gas phase reduction reaction under a hydrogen gas stream to prepare a supported catalyst loaded with 35% by weight of PtRu (primary supported catalyst).

0.769 g of the first supported catalyst was added to 400 g of ethylene glycol to prepare a first supported catalyst mixture. Then, 1.516 g of hexachloroplatinic acid (H₂PtCl₆.xH₂O) and 0.740 g of ruthenium chloride (RuCl₃.xH₂O), these amounts being 70% by weight of the final loading amount of catalytic metal, were dissolved in 200 g of triple-distilled water, and the resulting solution was added to the primary supported catalyst mixture. The pH of the resulting mixture was adjusted to pH 13, and then the mixture was heated to 110° C. to reduce the newly supplied catalytic metal ions in the solution phase.

The supported catalyst obtained as described above was filtered, washed with triple-distilled water, and freeze-dried to prepare a PtRu/MC supported catalyst containing 70% by weight of PtRu.

In Example 1, a PtRu/MC supported catalyst containing 35% by weight of PtRu was obtained by a primary gas phase reduction reaction, and a PtRu/MC supported catalyst containing 35% by weight of PtRu was obtained by a secondary liquid phase reduction reaction. Thus, the total loading amount of PtRu in the finally obtained supported catalyst was 70% by weight.

### EXAMPLE 2

1.08 g of hexachloroplatinic acid (H₂PtCl₆.xH₂O), which is a catalytic metal precursor, was dissolved in 6 ml of acetone to obtain a corresponding catalytic metal precursor mixture. Then, 1 g of mesoporous carbon as a carbon support was impregnated with the catalytic metal precursor mixture in a plastic bag. The impregnated carbon support was placed in an electric furnace and subjected to a gas phase reduction reaction under a hydrogen gas stream to prepare a supported catalyst loaded with 30% by weight of Pt (primary supported catalyst).

1.43 g of the primary supported catalyst was added to 260 g of ethylene glycol to prepare a primary supported catalyst mixture. Then, 2.692 g of hexachloroplatinic acid (H₂PtCl₆.xH₂O), this amount being 60% by weight of the final loading amount of catalytic metal, was dissolved in 300 g of triple-distilled water, and the resulting solution was added to the first supported catalyst mixture. The pH of the resulting mixture was adjusted to pH 11, and then the mixture was heated to 110° C. to reduce the newly supplied catalytic metal ions in the solution phase.

The supported catalyst obtained as described above was filtered, washed, and freeze-dried to prepare a 60 wt % Pt/MC supported catalyst.

In Example 2, a Pt/MC supported catalyst containing 30% by weight of Pt was obtained by a primary gas phase reduction reaction, and a Pt/MC supported catalyst containing 30% by weight of Pt was obtained by a secondary liquid phase reduction reaction, was obtained. Thus, the total loading amount of Pt in the finally obtained supported catalyst was 60% by weight.

### COMPARATIVE EXAMPLE 1

1 g of hexachloroplatinic acid (H₂PtCl₆.xH₂O) and 0.474 g of ruthenium chloride (RuCl₃.xH₂O), which are catalytic metal precursors, were dissolved in 100 g of triple-distilled water to obtain a corresponding catalytic metal precursor mixture, and then this catalytic metal precursor mixture was mixed with a carbon support mixture, in which the carbon support mixture was prepared by dispersing mesoporous carbon in ethylene glycol. The pH of the resulting mixture was adjusted to pH 13, and the mixture was heated to 110° C. to reduce the catalytic metal ions in the solution phase.

The supported catalyst obtained as described above was filtered, washed using a centrifuge, and freeze-dried to prepare a 70 wt % PtRu/MC supported catalyst.

In Comparative Example 1, a PtRu/MC supported catalyst containing 70% by weight of PtRu was obtained by a primary liquid phase reduction reaction.

### COMPARATIVE EXAMPLE 2

1.8844 g of hexachloroplatinic acid (H₂PtCl₆.xH₂O), which is a catalytic metal precursor, was dissolved in 6 ml of acetone to obtain a corresponding catalytic metal precursor mixture, and then 1 g of mesoporous carbon as a carbon support was impregnated with the catalytic metal precursor mixture in a plastic bag. The impregnated carbon support was placed in an electric furnace and was subjected to a gas phase reduction reaction under a hydrogen gas stream to prepare a 47.5 wt % Pt/MC supported catalyst. Then, 1.8844 g of hexachloroplatinic acid (H₂PtCl₆.xH₂O) was dissolved in 6 ml of acetone to obtain a corresponding catalytic metal precursor mixture. The Pt/MC catalyst prepared as described above was placed again in a plastic bag and was impregnated again with the secondary catalytic metal precursor mixture. The impregnated Pt/MC catalyst was placed in an electric furnace under a hydrogen gas stream to subject the newly supplied catalytic metal ions to secondary reduction in the gas phase in order to finally prepare a 60 wt % Pt/MC catalyst.

### COMPARATIVE EXAMPLE 3

1 g of a carbon support mesoporous carbon was dispersed in 400 g of water and 40 g of ethylene glycol. 3.7688 g of a catalytic metal precursor, hexachloroplatinic acid, was dissolved in 360 g of ethylene glycol to obtain a catalytic metal precursor mixture. The catalytic metal precursor mixture was then mixed with the dispersion of mesoporous carbon for 10 minutes. The pH of the resulting mixture was adjusted to pH 11, and was heated to reduce the catalytic metal ions in the solution phase.

The supported catalyst thus obtained was filtered, washed and dried to prepare a 60 wt % Pt/MC supported catalyst.

### EXAMPLE 3

1.5 g of the 70 wt % PtRu/MC supported catalyst obtained in Example 1 was mixed with 2 g of deionized water, 1 g of ethylene glycol and 2.25 g of a 20 wt % NAFION® ionomer solution to prepare a slurry for forming a catalyst layer.

The slurry for forming a catalyst layer was bar coated onto a polyethylene film to a thickness of about 30 μm, and then the coating was dried in a vacuum oven at 80° C. to form a 70 wt % PtRu/MC supported catalyst layer.

Subsequently, a PtRu black non-supported catalyst layer was formed on top of the 70 wt % PtRu/MC supported catalyst layer to form an anode catalyst layer. Here, the PtRu black non-supported catalyst layer was formed as described below.

3 g of PtRu black was mixed with 3 g of deionized water, 2 g of ethylene glycol and 1.875 g of a 20 wt % NAFION® ionomer solution to prepare a slurry for forming a catalyst layer. The slurry for forming a catalyst layer was coated onto the 70 wt % PtRu/MC supported catalyst layer and dried.

In a separate process, 1.667 g of the 60 wt % Pt/MC supported catalyst obtained in Example 2 was mixed with 1.2 g of deionized water, 2.5 g of ethylene glycol and 2.5 g of a 20 wt % NAFION® ionomer solution to prepare a slurry for forming a catalyst layer.

The slurry for forming a catalyst layer was bar coated onto a polyethylene film and was dried at 120° C. to form a 60 wt % Pt supported catalyst layer. Thus, a cathode catalyst layer was provided.

The anode catalyst layer and the cathode catalyst layer obtained as described above were respectively disposed on the two sides of an electrolyte membrane, and then the polyethylene films were peeled off from the cathode catalyst layer and the anode catalyst layer.

The resulting assembly was subjected to hot press at a temperature of 125° C. and at a pressure of 6 tons for 10 minutes to form a four-layered catalyst coated membrane (CCM). The CCM thus prepared was further provided with a cathode diffusion layer and an anode diffusion layer, each formed onto carbon paper, and then the whole assembly was hot pressed at a temperature of 125° C. for 3 minutes to prepare an eight-layered membrane electrode assembly (MEA).

### EXAMPLE 4

A membrane electrode assembly was produced in the same manner as in Example 3, except that the anode catalyst layer was produced using a PtRu black non-supported catalyst.

A PtRu black non-supported catalyst layer was formed to be used as the anode catalyst layer. Here, the PtRu black non-supported catalyst layer was produced as described below.

3 g of PtRu was mixed with 3 g of deionized water, 2 g of ethylene glycol and 1.875 g of a 20 wt % NAFION® ionomer solution to prepare a slurry for forming catalyst layer. The slurry was coated onto a polyethylene film and dried.

The anode catalyst layer thus obtained and a cathode catalyst layer produced in the same manner as in Example 3 were respectively disposed on each of the two sides of an electrolyte membrane, and then polyethylene films were peeled off from the cathode catalyst layer and the anode catalyst layer.

The resulting assembly was hot pressed at a temperature of 125° C. and at a pressure of 6 tons for 10 minutes to form a four-layered CCM. The CCM thus produced was further provided with a cathode diffusion layer and an anode diffusion layer, each formed onto carbon paper, and then the whole assembly was hot pressed at a temperature of 125° C. for 3 minutes to produce a seven-layered MEA.

### REFERENCE EXAMPLE 1

The anode catalyst layer was prepared as described below.

First, a PtRu non-supported catalyst layer was prepared as described below.

4 g of PtRu was mixed with 2 g of deionized water, 2.33 g of ethylene glycol and 1.25 g of a 20 wt % NAFION® ionomer solution to obtain a slurry for forming a catalyst layer. The slurry for forming a catalyst layer was coated onto a polyethylene film and dried.

On top of this PtRu non-supported catalyst layer, 2 g of the 70 wt % Pt/MC supported catalyst obtained in Example 1 was mixed with 2.67 g of deionized water, 2.33 g of ethylene glycol and 2.50 g of a 20 wt % NAFION® ionomer solution to prepare a slurry for forming a catalyst layer.

The slurry for forming a catalyst layer was bar coated onto a polyethylene film, and was dried at 80° C. to obtain a 70 wt % PtRu/MC catalyst layer.

In a separate process, 2 g of the 60 wt % Pt/MC supported catalyst obtained in Example 2 was mixed with 1.44 g of deionized water, 3 g of ethylene glycol and 3 g of a 20 wt % NAFION® ionomer solution to obtain a slurry for forming a catalyst layer.

The slurry for forming catalyst layer was bar coated onto a polyethylene film, and was dried at 120° C. to form a 60 wt % Pt supported catalyst layer. Thus, a cathode catalyst layer was provided.

The anode catalyst layer and the cathode catalyst layer obtained as described above were respectively disposed on each of the two sides of an electrolyte membrane, and then polyethylene films were peeled off from the cathode catalyst layer and the anode catalyst layer. Here, the PtRu/MC supported catalyst layer of the anode catalyst layer was disposed to be adjacent to the electrolyte membrane.

The resulting assembly was subsequently hot pressed at a temperature of 125° C. and at a pressure of 6 tons for 10 minutes to form a four-layered catalyst coated membrane (CCM). The CCM thus prepared was further provided with a cathode diffusion layer and an anode diffusion layer, each formed onto carbon paper, and then the whole assembly was hot pressed at a temperature of 125° C. for 3 minutes to produce an eight-layered membrane electrode assembly (MEA).

### COMPARATIVE EXAMPLE 4

2 g of Pt was mixed with 2 g of deionized water, 2.33 g of ethylene glycol and 1.25 g of a 20 wt % NAFION® ionomer solution to obtain a slurry for forming catalyst layer.

The slurry for forming a catalyst layer was bar coated onto a polyethylene film, and was dried at 120° C. to form a 60 wt % Pt supported catalyst layer. Thus, a cathode catalyst layer was provided.

6 g of PtRu was mixed with 2.67 g of deionized water, 2.33 g of ethylene glycol and 2.50 g of a 20 wt % NAFION® ionomer solution to obtain a slurry for forming a catalyst layer.

The slurry for forming a catalyst layer was bar coated onto a polyethylene film, and was dried at 80° C. to obtain a 70 wt % PtRuB catalyst layer (that is, PtRu without a carbon support).

The anode catalyst layer and the cathode catalyst layer obtained as described above were respectively disposed on each of the two sides of an electrolyte membrane, and then polyethylene films were peeled off from the cathode catalyst layer and the anode catalyst layer. The resulting assembly was subsequently hot pressed at a temperature of 125° C. and at a pressure of 6 tons for 10 minutes to form a four-layered CCM. The CCM thus prepared was further provided with a cathode diffusion layer and an anode diffusion layer, each formed onto carbon paper, and then the whole assembly was hot pressed at a temperature of 125° C. for 3 minutes to produce an eight-layered MEA.

For the supported catalysts prepared in Example 1 and Comparative Example 1, the particle diameter of PtRu and the methanol oxidation activity were measured, and the results are presented in Table 1 below. X-ray diffraction analysis spectra of the supported catalysts are shown in FIG. 5.

TABLE 1

| | Proportion of | Particle | Particle | Methanol | |
|---|---|---|---|---|---|
| | PtRu in PtRu/MC | diameter | diameter | oxidation | |
| | supported catalyst | of PtRu | of PtRu | activity^{c} | |
| | (wt %) | (nm)^{a} | (nm)^{b} | (A/g at 0.6 V) | Remarks |
| Example 1 | 70(*35-35) | 2.99 | 2.63 ± 0.41 | 16.19 | Gas phase |
| | | | | | reduction and |
| | | | | | liquid phase |
| | | | | | reduction applied |
| Comp. | 70 | 4.08 | 3.65 ± 0.89 | 12.71 | Liquid phase |
| Ex. 1 | | | | | reduction applied |

*The amount of PtRu loaded by a primary gas phase reduction reaction was 35% by weight, while the amount of PtRu loaded by a secondary liquid phase reduction reaction was 35% by weight.
^{a}determined by X-ray diffraction (XRD),
^{b}determined by transmission electron microscopy (TEM)
^{c}the MeOH oxidation activity was electrochemically measured in an aqueous solution of methanol and sulfuric acid, and the specific procedure was as follows.

The supported catalysts of Example 1 and Comparative Example 1 were respectively mounted on an operating electrode, and the methanol oxidation activity of the supported catalysts was measured using platinum and Ag/AgCl as a counter electrode and a reference electrode, respectively. A voltage of 0 to 0.8 V (vs. a normal hydrogen electrode or NHE) was applied in a 0.5 M aqueous solution of sulfuric acid and a 2 M aqueous solution of methanol, and the current was measured. The current density obtained at 0.6 V (vs. NHE), at which voltage methanol oxidation occurs most actively, was divided by the catalyst weight to obtain the methanol oxidation activity.

Referring to FIG. 5, the supported catalyst containing 70% by weight of PtRu particles prepared in Example 1 exhibited a broadening of the peak for PtRu(220) which appears at near 68.6°. From the results of calculating the crystal size of Pt(220) as shown in Table 1, it can be seen that the size of the PtRu particles of Example 1 was much smaller than that of the PtRu particles of Comparative Example 1. The average particle diameter of the PtRu particles obtained by TEM was also much smaller in the case of Example 1 than in the case of Comparative Example 1.

Furthermore, the methanol oxidation activity was found to be higher in the PtRu supported catalyst of Example 1 than in the PtRu supported catalyst of Comparative Example 1.

With respect to the supported catalyst prepared in Example 3, the anode catalyst layer was analyzed by scanning electron microscopy (SEM), and a photographic image thereof is shown in FIG. 8.

Referring to FIG. 8, it can be seen that the anode catalyst layer composed of the anodic first catalyst layer formed from a 70 wt % PtRu/MC and the anodic second catalyst layer formed from a PtRu black non-supported catalyst is disposed on one side of the electrolyte membrane, while a Pt/MC supported catalyst layer is formed onto the other side of the electrolyte membrane as the cathode catalyst layer.

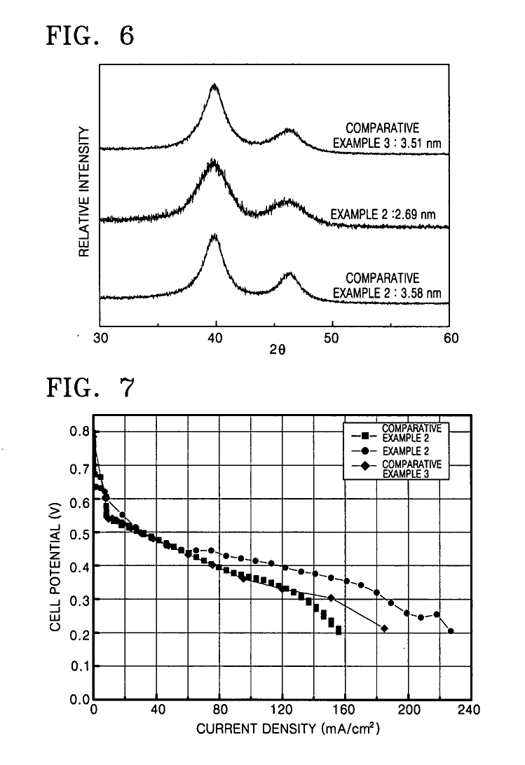

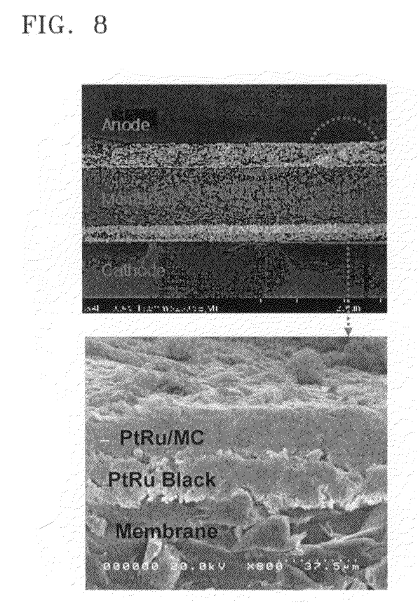

With respect to the supported catalysts prepared in Example 2, Comparative Example 2 and Comparative Example 3, the particle diameter of the Pt and the current density were measured, and the results are presented in Table 2 below. X-ray diffraction analysis spectra of these supported catalysts are shown in FIG. 6. Fuel cells were produced while using the supported catalysts prepared in Example 2, Comparative Example 2 and Comparative Example 3 in the cathode catalyst layers, and the unit cell performances of the fuel cells were compared, with the results being shown in FIG. 7.

TABLE 2

| | Proportion of | Particle | Particle | Current | |
|---|---|---|---|---|---|
| | Pt in Pt | diameter | diameter | density^{c} | |
| | supported | of Pt | of Pt | (mA/cm²@0.4 V, | |
| | catalyst | (nm)^{a} | (nm)^{b} | 50° C.) | Remarks |
| Example 2 | 60(*30-30) | 2.69 | 2.85 | 120.4 | Gas phase reduction and |
| | | | | | liquid phase reduction |
| | | | | | applied |
| Comp. | 60 | 3.58 | 3.71 | 79.7 | Gas phase reduction |
| Ex. 2 | | | | | applied |
| Comp. | 60 | 3.51 | 3.22 | 75.7 | Liquid phase reduction |
| Ex. 3 | | | | | applied |

*The amount of Pt loaded by a primary gas phase reduction reaction was 30% by weight, while the amount of Pt loaded by a secondary liquid phase reduction reaction was 30% by weight.
^{a}determined by X-ray diffraction (XRD),
^{b}determined by transmission electron microscopy (TEM)
^{c}Fuel cells were produced as described below, in order to evaluate the current density.

The supported catalysts prepared in Example 2, Comparative Example 2 and Comparative Example 3 were used for the cathode catalyst layers, and PtRu black was only used for the anode catalyst layers. Membrane electrode assemblies having the same structure were produced using these catalyst layers, and the current densities were compared.

Referring to the XRD spectra of FIG. 6, the peak for Pt(111) was found to be broader in the supported catalyst of Example 2, compared with the supported catalysts of Comparative Examples 2 and 3. This implies that the crystal size was smaller in the supported catalyst of Example 2. From the results shown in Table 2, it can be seen that the crystal size was near 3.5 nm in both of the cases of Comparative Example 2 and Comparative Example 3, while the crystal size in the case of Example 2 was smaller to be 2.69 nm. The same tendency was shown in the TEM results. The particle size of the supported catalyst of Example 2 measured by TEM was 2.85 nm, which was smaller than that of the supported catalysts of Comparative Examples 2 and 3.

From the results of FIG. 6 and Table 2, it can be seen that the fuel cell employing the supported catalyst of Example 2 had improved current density characteristics, compared with the fuel cells employing the supported catalysts of Comparative Example 2 and Comparative Example 3.

The current density and power characteristics of the MEAs produced in Example 3, Example 4 and Comparative Example 4 were measured, and the results are presented in Table 3. The current density and the power were measured by supplying a 1 M aqueous solution of methanol to the anode and air in an amount of three times the stoichiometrically required amount to the cathode at a unit cell temperature of 50° C. The current density and the power values obtained at an actual operating voltage of 0.4 V are compared in Table 3.

TABLE 3

| | | | Current |
|---|---|---|---|
| | | | density (mA/cm²)/Power |
| | Cathode | Anode | (mW/cm²) at 0.4 V |
| Comp. Ex. 4 | PtB* | PtRuB** | 76/30 |
| Example 3 | Pt/MC | 70(35-35) PtRu/MC | 140/56 |
| | | PtRuB | |
| Example 4 | Pt/MC | PtRuB | 120/48 |
| Ref. Ex. 1 | Pt/MC | PtRuB | 62/25 |
| | | 70(35-35) PtRu/MC | |

*PtB indicates a non-supported catalyst comprising Pt metal only without a carbon support.
**PtRuB indicates a non-supported catalyst comprising PtRu metal only without a carbon support.

Table 3 shows that the fuel cell prepared with the MEA of Example 3 had the PtRu non-supported catalyst layer disposed adjacent to the electrolyte membrane so as to reduce the interfacial resistance between the catalyst layer and the electrolyte membrane, and performed oxidation of the fuel which diffused through the PtRu supported catalyst, resulting in high performance. On the other hand, the fuel cell prepared with the MEA of Reference Example 1 employed the same supported catalysts as those used in the Examples, but did not show the same effect because the supported catalyst layer of the anode catalyst layer was disposed adjacent to the electrolyte membrane, thus resulting in rather lowered performance.

The CCM of this embodiment of the present invention comprises an anodic catalyst layer which is composed of a first catalyst layer comprising a non-supported catalyst, and a supported catalyst layer, and such anodic catalyst layer having a bilayer structure allows decreases in electrical resistance and interface resistance, and an increase in the catalyst utilization by the supported catalyst. Thus, when such a CCM and an MEA employing the same are used, the interface resistance between the electrodes and the electrolyte membrane is decreased, the amount of catalyst used in the electrode catalyst layers is decreased, and the thickness deviations in the electrode layers are decreased.

The fuel cell employing the MEA of this embodiment of the present invention exhibits a maximal activity of the supported catalyst, and thus, the output voltage, output density, efficiency and the like are improved.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A catalyst coated membrane (CCM) comprising:
an anode catalyst layer having an anodic first catalyst layer composed of a non-supported catalyst and an anodic second catalyst layer composed of a supported catalyst layer;
a cathode catalyst layer composed of a supported catalyst layer; and
an electrolyte membrane interposed between the anode catalyst layer and the cathode catalyst layer;
wherein the anodic first catalyst layer of the anode catalyst layer is disposed adjacent to the electrolyte membrane; and
wherein salts of the catalyst metals are first loaded on porous carbon supports and the mixtures are subjected to gas phase reduction, wherein additional salts of the catalytic metals are loaded on the porous carbon support containing reduced catalytic metals and the mixtures are subjected to liquid phase reduction reactions, and wherein the pH's of the resulting mixtures are adjusted and the mixtures are heated.

2. The catalyst coated membrane of claim 1, wherein the non-supported catalyst of the anodic first catalyst layer of the anode catalyst layer includes at least one metal selected from the group consisting of platinum (Pt), ruthenium (Ru), platinum-ruthenium alloys (PtRu), palladium (Pd), rhodium (Rh), iridium (Ir), osmium (Os) and gold (Au).

3. The catalyst coated membrane of claim 1, wherein the supported catalyst of the anodic second catalyst layer of the anode catalyst layer comprises metal particles of at least one metal selected from the group consisting of platinum (Pt), ruthenium (Ru), platinum-ruthenium alloys (PtRu), palladium (Pd), rhodium (Rh), iridium (Ir), osmium (Os) and gold (Au), supported by at least one carbon support selected from the group consisting of microporous activated carbon and mesoporous carbon (MC).

4. The catalyst coated membrane of claim 1, wherein the anodic first catalyst layer of the anode catalyst layer is a PtRu non-supported catalyst layer, while the anodic second catalyst layer of the anode catalyst layer is a PtRu/MC supported catalyst layer, and the cathode catalyst layer is a Pt/MC supported catalyst layer.

5. A membrane electrode assembly (MEA) comprising:
an anode including an anode diffusion layer, a backing layer, and an anode catalyst layer, which anode catalyst layer has an anodic first catalyst layer composed of a non-supported catalyst and an anodic second catalyst layer composed of a supported catalyst;
a cathode including a cathode catalyst layer composed of a supported catalyst, a cathode diffusion layer, and a backing layer; and
an electrolyte membrane interposed between the anode and the cathode,
wherein the anodic first catalyst layer of the anode catalyst layer is disposed adjacent to the electrolyte membrane.

6. The membrane electrode assembly of claim 5, wherein the non-supported catalyst of the anodic first catalyst layer of the anode catalyst layer includes at least one metal selected from the group consisting of platinum (Pt), ruthenium (Ru), platinum-ruthenium alloys (PtRu), palladium (Pd), rhodium (Rh), iridium (Ir), osmium (Os) and gold (Au).

7. The membrane electrode assembly of claim 5, wherein the supported catalyst of the anodic second catalyst layer of the anode catalyst layer comprises metal particles of at least one metal selected from the group consisting of platinum (Pt), ruthenium (Ru), platinum-ruthenium alloys (PtRu), palladium (Pd), rhodium (Rh), iridium (Ir), osmium (Os) and gold (Au), supported by at least one carbon support selected from the group consisting of microporous activated carbon and mesoporous carbon (MC).

8. The membrane electrode assembly of claim 5, wherein the anodic first catalyst layer of the anode catalyst layer is a PtRu non-supported catalyst layer, while the anodic second catalyst layer of the anode catalyst layer is a PtRu/MC supported catalyst layer, and the cathode catalyst layer is a Pt/MC supported catalyst layer.

9. A method of producing a membrane electrode assembly, the method comprising:
coating a composition for forming a cathode catalyst layer, which contains a supported catalyst, an ion-conductive binder and a solvent, onto a supporting film, and then drying the resultant to form the cathode catalyst layer on the supporting film;
coating a composition for forming an anodic second catalyst layer, which contains a supported catalyst, an ion-conductive binder and a solvent, onto a supporting film, and then drying the resultant to form the anodic second catalyst layer, and coating a composition for forming an anodic first catalyst layer, which contains a non-supported catalyst, an ion-conductive binder and a solvent, onto the anodic second catalyst layer, and then drying the resultant to form the anodic first catalyst layer;
disposing an electrolyte membrane between the cathode catalyst layer formed onto a supporting film, and the anodic first catalyst layer formed onto the anodic second catalyst layer, and performing a hot pressing of the resulting assembly;
peeling off the supporting films from the cathode catalyst layer side and the anodic second catalyst layer side of the resulting hot pressed assembly to obtain a catalyst coated membrane (CCM); and
sequentially laminating a cathode diffusion layer and a backing layer onto the exposed surface of the cathode catalyst layer of the CCM, sequentially laminating an anode diffusion layer and a backing layer onto the exposed surface of the anodic second catalyst layer, and performing a hot pressing of the resulting assembly.

10. The method of claim 9, wherein each hot pressing is performed at a temperature of 80 to 150° C. and at a pressure of 2 to 10 tons.

11. A fuel cell comprising the membrane electrode assembly of claim 5.

12. The method of claim 9, wherein each of the supporting films is selected from the group consisting of polyethylene, polyethylene terephthalate, polytetrafluoroethylene, and polyimide.

13. The method of claim 9, wherein each solvent is selected from the group consisting of water, ethylene glycol, isopropyl alcohol, and polyalcohols and wherein the solvent is used in the ratio of 1.5:1 to 2.5:1 by weight of the supported catalyst.

14. The method of claim 9, wherein each ion conductive binder is an ionomer comprising a main chain composed of a fluorinated alkylene and side chains composed of fluorinated vinyl ether and sulfonic acid groups at the terminals, and wherein each ion conductive binder is dispersed in a mixed solvent of water and alcohol at an amount of 5 to 50 percent of the supported catalyst.

15. The method of claim 9, wherein each backing layer is a porous material taken from the group consisting of carbon paper and carbon cloth.

16. The method of claim 15, wherein the porous material is carbon paper.

17. The method of claim 9, wherein the electrolyte membrane comprises a cation-exchangeable polymer electrolyte.

18. The method of claim 9, wherein the cation-exchangeable polymer electrolyte comprises a sulfonated, highly fluorinated polymer having a main chain composed of fluorinated alkylene and side chains composed of fluorinated vinyl ether and sulfonic acid groups.

19. A method of producing a membrane electrode assembly, the method comprising:
coating a composition for forming a cathode catalyst layer, which contains a supported catalyst, an ion-conductive binder and a solvent, onto a first side of an electrolyte membrane;
coating a composition for forming a supported anodic catalyst layer, which contains a supported catalyst, an ion-conductive binder and a solvent, onto a second side of the electrolyte membrane;
drying, and then performing a hot pressing of the three layers; and
sequentially laminating a cathode diffusion layer and a backing layer onto the exposed surface of the cathode catalyst layer, sequentially laminating an anode diffusion layer and a backing layer onto the exposed surface of the supported anodic catalyst layer, and performing a hot pressing of the seven layers.

20. The method of claim 19, wherein each hot pressing is performed at a temperature of 80 to 150° C. and at a pressure of 2 to 10 tons.

21. A method of producing a membrane electrode assembly, the method comprising:
coating a composition for forming a cathode catalyst layer, which contains a supported catalyst, an ion-conductive binder and a solvent, onto a first side of an electrolyte membrane;
coating a composition for forming a supported anodic catalyst layer, which contains a supported catalyst, an ion-conductive binder and a solvent, onto a non-supported anodic catalyst layer, which contains a non-supported catalyst, an ion-conductive binder and a solvent, drying the resultant to form an anodic catalyst layer, and placing the non-supported anodic catalyst layer face of the anodic catalyst layer onto a second side of the electrolyte membrane;
performing a hot pressing of the four layers; and
sequentially laminating a cathode diffusion layer and a backing layer onto the exposed surface of the cathode catalyst layer, sequentially laminating an anode diffusion layer and a backing layer onto the exposed surface of the supported anodic catalyst layer, and performing a hot pressing of the eight layers.

22. The method of claim 21, wherein each hot pressing is performed at a temperature of 80 to 150° C. and at a pressure of 2 to 10 tons.

23. A method of producing a membrane electrode assembly, the method comprising:
coating a composition for forming a cathode catalyst layer, which contains a supported catalyst, an ion-conductive binder and a solvent, onto a supporting film, and then drying the resultant to form the cathode catalyst layer on its supporting film;
coating a composition for forming an anodic catalyst layer, which contains a supported catalyst, an ion-conductive binder and a solvent, onto a supporting film, and then drying the resultant to form the anodic catalyst layer on its supporting film;
disposing an electrolyte membrane between the cathode catalyst layer formed onto its supporting film, and the anodic catalyst layer formed onto its supporting film, and performing a hot pressing of the five layers;
peeling off the supporting films from the cathode catalyst layer side and the anodic catalyst layer side of the five layered hot pressed assembly to obtain a three-layered catalyst coated membrane; and
sequentially laminating a cathode diffusion layer and a backing layer onto the exposed surface of the cathode catalyst layer, sequentially laminating an anode diffusion layer and a backing layer onto the exposed surface of the anodic catalyst layer, and performing a hot pressing of the seven layers.

24. The method of claim 23, wherein each hot pressing is performed at a temperature of 80 to 150° C. and at a pressure of 2 to 10 tons.

25. A catalyst coated membrane (CCM) comprising:
a carbon supported anode catalyst layer wherein a salt of the catalyst metal is first loaded on a porous carbon support and the mixture is subjected to a gas phase reduction, wherein additional salt of the catalytic metal is loaded on the porous carbon support containing reduced catalytic metal and the second mixture is subjected to a liquid phase reduction reaction, and wherein the pH of the second mixture is adjusted and the second mixture is heated;
a carbon supported cathode catalyst layer wherein a salt of the catalyst metal is first loaded on a porous carbon support and the mixture is subjected to a gas phase reduction, wherein additional salt of the catalytic metal is loaded on the porous carbon support containing reduced catalytic metal and the second mixture is subjected to a liquid phase reduction reaction, and wherein the pH of the second mixture is adjusted and the second mixture is heated; and
an electrolyte membrane interposed between the anode catalyst layer and the cathode catalyst layer.

26. The catalyst coated membrane of claim 25, wherein the anode catalyst layer is a PtRu/MC supported catalyst and the cathode catalyst layer is a Pt/MC supported catalyst.

27. The catalyst coated membrane of claim 26, wherein the anode catalyst layer is a PtRu catalyst and the cathode catalyst layer is a Pt catalyst.

28. The catalyst coated membrane of claim 1, wherein the thickness of the anodic first catalytic layer and the anodic second catalyst layer range from 10 to 40 μm each and the ratio of the thickness of the anodic first catalytic layer to the anodic second catalytic layer ranges from 2:1 to 1:2.
